(19) United States
(12) Patent Application Publication
(10) Pub. No.: US 2026/0227539 A1
(43) Pub. Date: Aug. 6, 2026

(54) METHOD AND APPARATUS FOR CHARACTERIZING NON-UNIFORM SPATIAL DISTRIBUTION CHARACTERISTICS OF MULTI-SCALE GEOSTRESS FIELD

(71) Applicant: Institute of Geomechanics,Chinese Academy of Geological Sciences, Beijing (CN)

(72) Inventors: Wen Meng, Beijing (CN); Dongsheng Sun, Beijing (CN); Chongyuan Zhang, Beijing (CN); Xianghui Qin, Beijing (CN); Yuehui Yang, Beijing (CN); Ran Li, Beijing (CN); Bangchen Wu, Beijing (CN); Weifeng Sun, Beijing (CN); Awei Li, Beijing (CN); Qunce Chen, Beijing (CN)

(21) Appl. No.: 19/430,289

(22) Filed: Dec. 23, 2025

(30) Foreign Application Priority Data
Feb. 6, 2025 (CN) 202510132248.1

(51) Int. Cl. G01V 1/30

(52) U.S. Cl. CPC G01V 1/306; G01V 1/301

(57) ABSTRACT

A method and an apparatus for characterizing non-uniform spatial distribution characteristics of multi-scale geostress field are provided. The method includes: obtaining stress occurrence states at different crustal depths; obtaining deformation characteristics at the different crustal depths; calculating crustal stress field distribution characteristics using constraints of measured stress states, inverted stress states, and the deformation characteristics at the different crustal depths; and obtaining correlation and non-uniformity characterization of stresses of deep and shallow crusts, based on directions, magnitudes, stress structures, and deformation characteristics in the crustal stress field distribution characteristics. By employing the technical solution of this invention, it is possible to comprehensively evaluate occurrence characteristics of geostress, stress field non-uniform distribution characteristics, and coupling of stress fields of deep and shallow crusts.

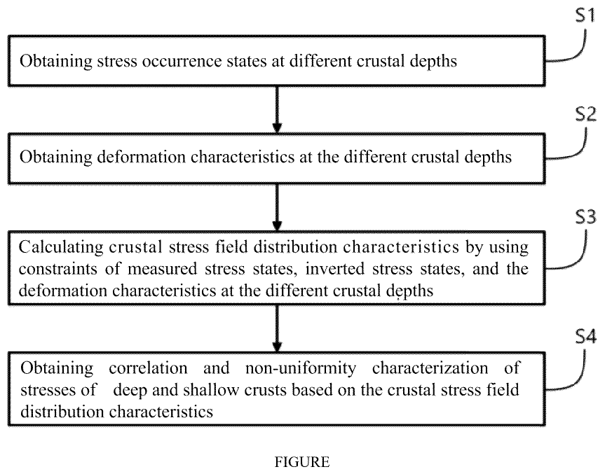

### CROSS-REFERENCE TO RELATED APPLICATION

This application claims priority to Chinese patent application No. 202510132248.1, filed to China National Intellectual Property Administration (CNIPA) on Feb. 6, 2025, which is herein incorporated by reference in its entirety.

### TECHNICAL FIELD

The disclosure relates to the field of geomechanics technologies, and in particular to a method and an apparatus for characterizing non-uniform spatial distribution characteristics of multi-scale geostress field.

### BACKGROUND

Crustal stresses are closely related to tectonic activities such as crustal deformation, faults, earthquakes, and associated geological hazards. Revealing current states and laws of crustal stresses is of great significance for studying and solving major engineering geological problems such as fault instability and sliding, regional crustal stability, and rock stability during major engineering planning and construction processes. For a long time, how to obtain reliable current crustal stress states has been an urgent problem in various fields of earth science. Different needs and conditions have given rise to different methods for obtaining geostress, including geostress observations based on rock cores and boreholes, as well as geological structure and geophysical inversion methods. With Earth system science becoming the guiding ideology of Earth science research, coupling relationships between deep Earth processes and surface processes are increasingly receiving attentions. Under the interaction of tectonic movement and geostress, in addition to continuity of large-scale stress fields controlled by plate movements, non-uniformity of geostress distribution in space is a common phenomenon. Stress directions and stress magnitudes exhibit distinct local characteristics. Therefore, it is very important to reveal distribution characteristics and occurrence states of geostress fields at different scales. However, at present, acquisition of crustal stress occurrence characteristics mainly employs a single method constraint, or is based on in-situ testing methods such as a hydraulic fracturing method, a borehole collapse method, a stress relief method, etc., or based on a focal mechanism solution method, numerical simulation method, and so on for conducting tectonic stress field inversions. There is a lack of a comprehensive evaluation method for coupling and mutual feedback processes of different depths.

### SUMMARY

A technical problem to be solved by the disclosure is to provide a method and an apparatus for characterizing non-uniform spatial distribution characteristics of multi-scale geostress fields. To achieve the above objectives, the disclosure provides the following technical solutions.

A method for characterizing non-uniform spatial distribution characteristics of multi-scale geostress field, including:
step S1, obtaining stress occurrence states at different crustal depths;
step S2, obtaining deformation characteristics at the different crustal depths;
step S3, establishing a finite element model of a target area and calculating stress field distribution by using constraints of measured stress states, inverted stress states, and the deformation characteristics at the different crustal depths, to thereby obtain crustal stress field distribution characteristics; and
step S4, obtaining correlation and non-uniformity characterization of stresses of deep and shallow crusts, based on stress field directions, stress field magnitudes, stress structures, and deformation characteristics of the deep and shallow crusts in the crustal stress field distribution characteristics.

In an embodiment, in step S1, stress states at different depths of an upper crust (also referred to as measured stress states) are obtained using an in-situ stress measurement method and a borehole and rock core based testing method, and stress states at focal depths (also referred to as inverted stress states) are obtained using a focal mechanism solution inversion method.

In an embodiment, in step S2, the deformation characteristics at the different crustal depths are obtained using surface deformation observation and seismic anisotropy research methods.

In an embodiment, in step S4, the stress field directions are characterized by a maximum horizontal principal stress direction; the stress field magnitudes are characterized by principal stress values, lateral compression coefficients, stress accumulation parameters, and relative stress magnitudes; types of the stress structures are determined based on Anderson fault types and stress relationships; and the deformation characteristics of the deep and shallow crusts are characterized by maximum horizontal tensile strain rate-minimum horizontal principal stress-anisotropic fast wave (also referred to as fast shear-wave) polarization direction.

In an embodiment, the method further includes: superposing the correlation and non-uniformity characterization of stresses of deep and shallow crusts obtained in step S4 onto a base geological map to obtain a composite geostress map for displaying on a display screen, the composite geostress map is configured for use in engineering geological assessment or tectonic hazard analysis.

The disclosure also provides an apparatus for characterizing non-uniform spatial distribution characteristics of multi-scale geostress field, including:
a first acquisition module, configured (i.e., structured and arranged) to obtain stress occurrence states at different crustal depths;
a second acquisition module, configured to obtain deformation characteristics at the different crustal depths;
a calculation module, configured to establish a finite element model of a target area and calculate stress field distribution by using constraints of measured stress state, inverted stress states, and the deformation characteristics at the different crustal depths, to thereby obtain crustal stress field distribution characteristics; and
a processing module, configured to obtain correlation and non-uniformity characterization of stresses of deep and shallow crusts, based on stress field directions, stress field magnitudes, stress structures, and deformation characteristics of the deep and shallow crusts in the crustal stress field distribution characteristics.

In an embodiment, the first acquisition module is specifically configured to obtain measured stress states at different crustal depths using an in-situ stress measurement method and a borehole and rock core based testing method, and obtain inverted stress states using a focal mechanism solution inversion method.

In an embodiment, the second acquisition module is specifically configured to obtain the deformation characteristics at different crustal depths using surface deformation observation and seismic anisotropy testing methods.

In an embodiment, the stress field directions are characterized by a maximum horizontal principal stress direction; the stress field magnitudes are characterized by principal stress values, lateral compression coefficients, stress accumulation parameters, and relative stress magnitudes; types of the stress structures are determined based on Anderson fault types and stress relationships; and the deformation characteristics of the deep and shallow crusts are characterized by maximum horizontal tensile strain rate-minimum horizontal principal stress-anisotropic fast wave polarization direction.

In an embodiment, the processing module is configured to further superpose the correlation and non-uniformity characterization of stresses of deep and shallow crusts onto a base geological map to obtain a composite geostress map for displaying on a display screen, the composite geostress map is configured for use in engineering geological assessment or tectonic hazard analysis.

The disclosure provides multi-scale comprehensive analysis of integrating qualitative-semi-quantitative-quantitative methodologies that can effectively evaluate the crustal stress fields, horizontal scales including key site-specific locations and regional continuous scales, while vertical scales ranging from the shallow subsurface (near-surface crust) to the upper crust (also referred to as brittle layer/regime) and middle-to-lower crust (also referred to as ductile layer/regime), which can comprehensively evaluate geostress occurrence characteristics, stress field non-uniform distribution characteristics, and coupling of stress fields of deep and shallow crusts.

### BRIEF DESCRIPTION OF DRAWING

In order to more clearly illustrate technical solutions in embodiments of the disclosure or the related art, the accompanying drawing required for describing the embodiments or the related art will be briefly introduced below. Apparently, the drawing described below is merely some embodiments of the disclosure. For those skilled in the art, other drawings may be derived from the described drawings without creative effort.

The FIGURE is a schematic flowchart of a method for characterizing non-uniform spatial distribution characteristics of multi-scale geostress field according to embodiment 1 of the disclosure.

### DETAILED DESCRIPTION OF EMBODIMENTS

The following description will clearly and completely explain the technical solutions of the embodiments of the disclosure with reference to the accompanying drawing. It should be understood that the described embodiments are merely some of embodiments of the disclosure and not all of embodiments of the disclosure. All other embodiments obtained by those skilled in the art based on the described embodiments of the disclosure without creative labor fall within the scope of protection of the disclosure.

To make the aforementioned objectives, features, and advantages of the disclosure more readily apparent and understandable, the disclosure will now be described in further detail with reference to the accompanying drawing and specific embodiments.

### Embodiment 1

As shown in the FIGURE, an embodiment of the disclosure provides a method for characterizing non-uniform spatial distribution characteristics of multi-scale geostress field, which includes the following steps S1-S4.
Step S1, obtaining stress occurrence states at different crustal depths.
Step S2, obtaining deformation characteristics at the different crustal depths.
Step S3, establishing a three-dimensional geomechanical model that conforms to an actual geological structure, a fault geometry, and wave velocity structure characteristics of a target area; using the Maxwell body constitutive relationship to describe an iscoelastic behavior of crustal deformation; and establishing/constructing a finite element model of the target area and calculating stress field distribution using constraints of measured stress state, inverted stress states, and the deformation characteristics at the different crustal depths to thereby obtain crustal stress field distribution characteristics.
Step S4, obtaining correlation and non-uniformity characterization of stresses of deep and shallow crusts, based on stress field directions, stress field magnitudes, stress structures, and deformation characteristics of the deep and shallow crust in the crustal stress field distribution characteristics.

As an embodiment of the disclosure, in step S1, stress states at different depths of an upper crust are obtained using an in-situ stress measurement method or other method, and stress states at different crustal depths are obtained using a focal mechanism solution inversion method.

More specifically, the in-situ stress measurement method is used to obtain the stress states of a shallow crustal portion. In particular, for the geostress field acquistion of a shallow subsurface/near-surface crust (generally less than 3 kilometers), the in-situ testing method based on a borehole(s) (such as hydraulic fracturing method) is used to obtain magnitudes and directions of geostress at different depths of a single borehole or a borehole group, thereby quantitatively obtain the occurrence states of geostress.

The hydraulic fracturing method uses a pair of inflatable rubber packers to isolate a section of a borehole at a selected measurement depth, and fluid is then pumped into the isolated section to increase pressure until fractures are induced in the surrounding borehole wall. During the fracturing process, a pressure change curve over time (also referred to as measured curve) is recorded. A breakdown pressure P_{b}, an instantaneous shut-in pressure Pₛ, and a fracture reopening pressure Pᵣ can be obtained from the measured curve. According to relevant formulas, a maximum horizontal principal stress σ_{H}, a minimum horizontal principal stress σₕ, a vertical principal stress σᵥ, and a rock tensile strength T can be calculated out. If the induced fracture is vertical, i.e., parallel to the vertical pressure/stress, a direction of the maximum horizontal stress can be determined based on a direction of the fracture obtained by an impression packer.

$${σ}_{H} = 3 {P}_{s} - {P}_{r} - {P}_{o}$$

$$T = {P}_{b} - {P}_{r}$$

$${σ}_{h} = {P}_{s}$$

$${σ}_{v} = γ H$$

Where Pₒ represents a pore pressure, γ represents a unit weight of an overlying rock mass in the test section, H represents a thickness of the overlying rock mass in the test section.

A borehole and rock core based testing method is used to obtain stress states of the upper crust. In particular, due to current in-situ stress measurement method only being able to obtain data of the shallow crustal portion of less than 3 kilometers; in order to quantitatively obtain stress states of deeper portions of the upper crust, it is necessary to use the borehole and rock core based method, including a borehole breakout/induced tensile fracture method and an anelastic strain recovery method, to obtain magnitudes and directions of stress at different depths of a single borehole or a borehole group, thereby quantitatively obtain the occurrence states of geostress.

Furthermore, the focal mechanism solution inversion method is used to obtain inverted stress states. In particular, by utilizing natural earthquakes or induced earthquakes, the focal mechanism solution inversion method (such as CAP, HASH, BABO) is applied to obtain focal mechanism solution data; and based on the volume of data, the study area is divided into several fine grid cells (such as 0.5°×0.5°) based on the amount of data. A stress field inversion method (such as MSATSI method, Stress Inverse method) is then used to obtain stress tensors and tectonic stress field characteristics of respective grid partitions at different depths.

As an embodiment of the disclosure, in step S2, surface deformation observation and seismic anisotropy testing methods are used to obtain the deformation characteristics at the different crustal depths.

More specifically, using GPS crustal deformation observation data, continuous strain rate field and velocity field of the shallow subsurface (i.e., near surface crust) are calculated out based on a spherical wavelet multi-scale method proposed by Tape et al., thereby obtaining a maximum horizontal tensile strain rate and a maximum horizontal compressive strain rate. Firstly, a spherical surface is partitioned to generate discretized grid points, and wavelet functions of different scales are constructed with the discretized grid points obtained as central poles. Then, the observation data are expressed as a linear combination of wavelet frames, and wavelet coefficients are solved using the least square method or other optimization method. Finally, multi-scale analysis is conducted using the obtained wavelet coefficients, and distribution characteristics at different spatial resolutions can be extracted through stepwise refinement or coarsening of scales. The GPS velocity field on the spherical surface can be expressed as:

$$v ( θ , ϕ ) = {v}_{r} ( θ , ϕ ) \hat{r} + {v}_{θ} ( θ , ϕ ) \hat{θ} + {v}_{θ} ( θ , ϕ ) \hat{ϕ}$$

Where \hat{r}, \hat{θ} and \hat{φ} respectively represent three directions of station velocity in vertical, north-south, and east-west directions; θ represents latitude and φ represents longitude. Wavelet basis functions are constructed using GPS velocities unevenly distributed on the Earth's surface to describe geophysical phenomena at different spatial scales and characteristics of different noise sources.

Seismic waveform data are used to obtain anisotropy characteristics at different crustal depths, and obtain corresponding anisotropy parameters of fast wave direction and slow wave delay time. The anisotropy of the upper crust is calculated using near seismic shear-wave splitting, selecting waveform records with a magnitude less than 4.0, an epicentral distance less than 25 km, an incidence angle smaller than 45°, and a signal-to-noise ratio greater than 5.0. The anisotropy of whole-crust is calculated using Pms wave splitting parameters of a receiver function. Waveform records of an earthquake event with a magnitude greater than 5.0, an epicentral distance ranging from 30° to 90°, a clear seismic phase, and a signal-to-noise ratio greater than 5.0 are selected. A P-wave receiver function is extracted using a time-domain deconvolution method, and stations with clear waveforms and radial receiver functions exhibiting a cos 2θ variation pattern are selected for splitting parameter calculation. Optimal splitting parameters are obtained through a grid search of the Pms phase of a radial receiver function superposed with a maximum amplitude. Reasonable fast wave direction and delay time search step lengths (such as 1 degree and 0.02 seconds) are set, and a reference arrival time search window is set as 5-10 seconds.

Furthermore, based on the obtained maximum horizontal tensile strain rate, the maximum horizontal compressive strain rate, the anisotropy parameters of fast wave direction and slow wave delay time, and crustal tectonic stress field distribution, deformation characteristics at the different crustal depths are obtained consequently.

As an embodiment of the disclosure, in step S3, a finite element method is used to simulate and calculate the crustal stress field distribution characteristics. In particular, the finite element model of the target area is established and the stress field distribution is calculated using constraints of different depths of geostress data, rock mechanics data obtained in laboratory, and deformation data at different crustal depths, thereby obtain continuous stress field distribution characteristics.

As an embodiment of the disclosure, in step S4, the stress field directions are characterized by the direction of maximum horizontal principal stress (also referred to as maximum horizontal principal stress direction); the stress field magnitudes are characterized by principal stress values, lateral compression coefficients, stress accumulation parameters, and relative stress magnitudes; types of stress structures are determined based on Anderson fault types and stress relationships; the deformation characteristics of the deep and shallow crusts are characterized by the maximum horizontal tensile strain rate—the minimum horizontal principal stress-anisotropic fast wave polarization direction. By analyzing the distribution characteristics of stress field and deformation field at different depths, and establishing a coherent deformation pattern of shallow subsurface (near-surface crust)—upper crust—middle-to-lower crust, their coupling relationships and differences are revealed consequently. Herein, the shallow subsurface (or near-surface crust) generally is located at the very top, constituting the uppermost part of the upper crust, and its depth range typically refers to the zone from 0 to 1-2 km below the surface, i.e., less than 3 km below the surface; the upper crust generally is situated in the upper part of the crust, encompassing the shallow subsurface and extending downwards, and its depth range typically extends from the surface to approximately 10-15 km (the specific depth is determined by the geothermal gradient, i.e., the depth of the “brittle-ductile transition zone”); the middle-to-lower crust generally lies beneath the upper crust, extending down to the base of the crust (the Moho discontinuity), and its depth range typically extends from approximately 10-15 km to the base of the crust (typically 30-50 km deep for continental crust); and the deep and shallow crusts refer to the middle-to-lower crust and the shallow-to-upper crust, respectively.

### Embodiment 2

This embodiment of the disclosure provides an apparatus for characterizing non-uniform spatial distribution characteristics of multi-scale geostress field, which includes several modules as follows.

A first acquisition module, configured (i.e., structured and arranged) to obtain stress occurrence states at different crustal depths;
a second acquisition module, configured to obtain deformation characteristics at the different crustal depths;
a calculation module, configured to establish a finite element model of a target area and calculate stress field distribution by using constraints of measured stress states, inverted stress states, and the deformation characteristics at the different crustal depths, to thereby obtain crustal stress field distribution characteristics; and
a processing module, configured to obtain correlation and non-uniformity characterization of stresses of deep and shallow crusts, based on stress field directions, stress field magnitudes, stress structures, and deformation characteristics of the deep and shallow crusts in the crustal stress field distribution characteristics.

As an embodiment of the disclosure, the first acquisition module is specifically configured to obtain the measured stress states at different crustal depths using an in-situ stress measurement method and a borehole and rock core based testing method, and obtain the inverted stress states using a focal mechanism solution inversion method.

As an embodiment of the disclosure, the second acquisition module is specifically configured to obtain the deformation characteristics at different crustal depths using surface deformation observation and seismic anisotropy testing methods.

As an embodiment of the disclosure, the stress field directions are characterized by a maximum horizontal principal stress direction; the stress field magnitudes are characterized by principal stress values, lateral compression coefficients, stress accumulation parameters, and relative stress magnitudes; types of the stress structures are determined based on Anderson fault types and stress relationships; and the deformation characteristics of the deep and shallow crusts are characterized by maximum horizontal tensile strain rate-minimum horizontal principal stress-anisotropic fast wave polarization direction.

In some embodiments, the first acquisition module, the second acquisition module, the calculation module, and the processing module described above may be implemented/embodied by one or more memories stored software modules therein and one or more processors coupled to the one or more memories and configured to execute the software modules.

The embodiments described above are merely illustrative of preferred implementations of the disclosure and are not intended to limit the scope of protection of the disclosure. Any variations or modifications made by those skilled in the art based on the described technical solutions of the disclosure without departing from the inventive concept shall fall within the scope of protection defined by the appended claims of the disclosure.

What is claimed is:

1. A method for characterizing non-uniform spatial distribution characteristics of multi-scale geostress field, comprising:
step S1, obtaining stress occurrence states at different crustal depths;
step S2, obtaining deformation characteristics at the different crustal depths;
step S3, establishing a finite element model of a target area and calculating stress field distribution by using constraints of measured stress states, inverted stress states, and the deformation characteristics at the different crustal depths, to thereby obtain crustal stress field distribution characteristics; and
step S4, obtaining correlation and non-uniformity characterization of stresses of deep and shallow crusts, based on stress field directions, stress field magnitudes, stress structures, and deformation characteristics of the deep and shallow crusts in the crustal stress field distribution characteristics;
wherein in step S1, stress states at different depths of an upper crust are obtained using an in-situ stress measurement method and a borehole and rock core based testing method, and stress states at focal depths are obtained using a focal mechanism solution inversion method;
wherein in step S2, the deformation characteristics at the different crustal depths are obtained using surface deformation observation and seismic anisotropy methods; and
wherein in step S4, the stress field directions are characterized by a maximum horizontal principal stress direction; the stress field magnitudes are characterized by principal stress values, lateral compression coefficients, stress accumulation parameters, and relative stress magnitudes; types of the stress structures are determined based on Anderson fault types and stress relationships; and the deformation characteristics of the deep and shallow crusts are characterized by maximum horizontal tensile strain rate-minimum horizontal principal stress-anisotropic fast wave polarization direction.

2. An apparatus for characterizing non-uniform spatial distribution characteristics of multi-scale geostress field, comprising:
a first acquisition module, configured to obtain stress occurrence states at different crustal depths;
a second acquisition module, configured to obtain deformation characteristics at the different crustal depths;
a calculation module, configured to establish a finite element model of a target area and calculate stress field distribution by using constraints of measured stress states, inverted stress states, and the deformation characteristics at the different crustal depths, to thereby obtain crustal stress field distribution characteristics; and
a processing module, configured to obtain correlation and non-uniformity characterization of stresses of deep and shallow crusts, based on stress field directions, stress field magnitudes, stress structures, and deformation characteristics of the deep and shallow crusts in the crustal stress field distribution characteristics;
wherein the first acquisition module is specifically configured to obtain stress states at different depths of an upper crust using an in-situ stress measurement method and a borehole and rock core based testing method, and obtain stress states at focal depths using a focal mechanism solution inversion method;
wherein the second acquisition module is specifically configured to obtain the deformation characteristics at the different crustal depths using surface deformation observation and seismic anisotropy methods;
wherein the stress field directions are characterized by a maximum horizontal principal stress direction; the stress field magnitudes are characterized by principal stress values, lateral compression coefficients, stress accumulation parameters, and relative stress magnitudes; types of the stress structures are determined based on Anderson fault types and stress relationships; and the deformation characteristics of the deep and shallow crusts are characterized by maximum horizontal tensile strain rate-minimum horizontal principal stress-anisotropic fast wave polarization direction.
